(19) United States
(12) Patent Application Publication
(10) Pub. No.: US 2020/0189967 A1
(43) Pub. Date: Jun. 18, 2020

(54) MECHANICALLY STRONG TINTED GLASS SUBSTRATE COATED WITH A MINERAL PAINT FOR A MOTOR VEHICLE ROOF

(71) Applicant: SAINT-GOBAIN GLASS FRANCE, COURBEVOIE (FR)

(72) Inventors: François COMPOINT, TOURS (FR); Louis GARNIER, PARIS (FR)

(21) Appl. No.: 16/617,750

(22) PCT Filed: May 30, 2018
(86) PCT No.: PCT/FR2018/051244

§ 371 Date: Nov. 27, 2019

(30) Foreign Application Priority Data
May 31, 2017 (FR) 1754814

(51) Int. Cl. C03C 17/00; C03C 1/00

(52) U.S. Cl. CPC C03C 17/007; C03C 1/008; C03C 2217/485; C03C 2217/475; C03C 2218/118; C03C 2218/119; C03C 2218/112

(57) ABSTRACT

A temperable tinted glass substrate has at least one of its faces that is partially coated with a layer of mineral paint obtained from an aqueous paint composition based on an alkali metal silicate solution including the mixing of a platy mineral filler with at least one other filler chosen from alumina, boron or germanium, and at least one black mineral pigment.

The present invention relates to a tinted glass substrate partially coated with a mineral paint, making it possible to give the substrate improved mechanical strength. The substrate is in particular used as glazing for a motor vehicle roof.

The glazings used for motor vehicle roofs are usually tempered glazings that have undergone a heat treatment at high temperature, i.e. at temperatures above 650° C. and generally around 700° C. The edges of the glazings used in the motor vehicle are customarily covered with a band of black paint that makes it possible in particular to hide the elements located at the edges, such as for example seals or cables. These paints are mainly of enamel type, i.e. consisting of a mixture of glass frit, organic resin, solvents and black pigments. Enamel paints are necessarily tempered, therefore undergo a high-temperature heat treatment, which enables them to adhere to the glazing. They are consequently deposited on the glazing before the shaping and tempering step. However, enamels have a tendency to mechanically weaken the glass and thus the mechanical strength of glass coated with a layer of enamel, tested in the drop ball test, is significantly lower than that of uncoated glass, with no enamel layer. This weakening is explained in particular by the difference in thermal expansion coefficient that may exist between the components of the enamel layer (frit, pigments or fillers) and the glass, which generates stresses during the high-temperature heat treatment. The weakening may also be explained by the presence of bubbles in the enamel layer, which form potential initiation points for cracks capable of propagating within the layer. The very good adhesion of the enamel layers to teh glass leads to propagation of the cracks in the glass and a premature fracture of the latter during a mechanical stress, even a small mechanical stress.

Organic paints that might weaken the glass less do not however meet the specification sought in the precise case of tempered glazings since they are not temperable, as they do not withstand the temperatures at which the tempering is carried out. It is not therefore possible to apply them to the glazing before the shaping and tempering steps.

Mineral paints, in particular based on silicates, are known for being temperable paints used for motor vehicles and can be applied before the tempering step. Mention will for example be made of U.S. Pat. No. 6,176,919 which describes an aqueous paint comprising sodium silicate in which a large amount of amorphous silica is added to improve the mechanical strength. The solution proposed in this patent is not entirely satisfactory since the addition of silica to the silicate network has a tendency to accelerate the polymerization of the silicate species and to give rise to a solidification of the paste when applied by screenprinting to the glass.

A paint is therefore sought that can both be applied easily for example by screenprinting but also by any other liquid process (spray coating, curtain coating, etc.) to the glass substrate, and which does not weaken the latter. The inventors have surprisingly discovered that the presence of certain mineral fillers in the composition of a silicate-based paint made it possible to limit the weakening of the glass coated with the paint.

The present invention relates to a temperable tinted glass substrate, at least one of the faces of which is partially coated with a mineral paint obtained from an aqueous paint composition based on an alkali metal silicate solution comprising the mixing of a platy mineral filler with at least one other filler chosen from alumina, boron or germanium, and at least one black mineral pigment.

Advantageously, the weight ratio between the alkali metal silicate and all of the mineral fillers including the pigment is between 0.05 and 2. Preferably, the weight ratio between the alkali metal silicate and all of the mineral fillers including the pigment is between 0.1 and 1. A larger amount of mineral filler relative to the amount of alkali metal silicate makes it possible to improve the mechanical strength. Even more preferentially, the weight ratio between the alkali metal silicate and all of the mineral fillers including the black mineral pigment is between 0.1 and 0.3. Specifically, the inventors have noted that too large an amount of silicate in the mineral paint composition has a tendency to degrade the paint, causing the appearance of bubbles in particular after a heat treatment such as a tempering. A paint comprising more mineral fillers than alkali metal silicate is less sensitive to weakening during the heat treatments.

The platy mineral filler is preferably talc, mica, or clays based on silicate or on aluminosilicate such as kaolinite, illite, montmorillonite or sepiolite.

Very preferentially, the mineral filler of the paint comprises, in particular is, a mixture of talc and alumina. Advantageously, the amount of alumina in the talc/alumina mixture is greater than the amount of talc.

The mixture of mineral fillers having a layered structure (platy fillers) with other fillers of somewhat spherical structure, the thermal expansion coefficients of which are relatively similar to that of the glass makes it possible to give the paint a very good mechanical strength and also a good adhesion.

The amount of mineral filler preferably represents between 20% and 50% by weight of the aqueous mineral paint composition.

The black mineral pigment may for example be a pigment based on metals such as iron, chromium, copper, cobalt and/or manganese, in the form of oxides or sulfides. The preferred pigments are preferably free of chromium due to problems linked to the toxicity and the recycling of this metal. Advantageously, the amount of black mineral filler preferably represents between 1% and 25% by weight of the aqueous mineral paint composition. Too small an amount of black mineral pigment in the paint composition does not make it possible to obtain the desired black/gray appearance. The particle size of the mineral fillers in pulverulent form is preferentially between 1 and 10 μm, this particle size favoring in particular the pacity of the paint. The particle size value corresponds to the D₉₀, therefore 90% of the particles have a size between 1 and 10 μm.

The aqueous mineral paint composition comprises between 10% and 55% by weight, in particular between 15% and 45% by weight, and more preferentially still between 15% and 25% by weight of sodium silicate, potassium silicate and/or lithium silicate.

Advantageously, the aqueous mineral paint composition further comprises a dispersant, an anti-foaming agent, a thickener, a stabilizer and/or a curing agent, in amounts representing between 0.01% and 5% by weight of the aqueous mineral paint composition.

The substrate according to the present invention is preferably obtained by drying the aqueous paint composition at a temperature below 250° C.

The mineral paint layer, measured after drying, preferably has a thickness of at least 1 μm, preferably of at least 5 μm. Advantagously, the thickness of the paint measured after drying is less than 50 μm.

The presence of certain light-colored mineral fillers in the mineral paint composition generates a more gray than black appearance. Consequently, the glass substrate to which the mineral paint is applied is a tinted glass. The light transmission TL_{A} (D65 illuminant) of the tinted glass substrate is in particular less than 30%, and preferably less than 20% for a thickness of 4 mm. The light transmission is necessarily measured on a portion of the glazing not comprising the mineral paint coating (uncoated).

The color coordinates, L*a*b*, are calculated by taking into account the D65 illuminant and the CIE-1931 reference observer. They are the color coordinates obtained in reflection from the side of the face opposite the one on which the mineral paint is deposited. The component L* defines the clarity, and takes values between 0 for black and 100 for white. The components a* and b* may optionally be measured. They represent the color ranges, which are preferentially neutral and consequently tend toward 0. A paint is perceived as black if the value of the lightness L* is less than 15, or even less than 10. By way of comparison, the enamels used for the edges of motor vehicle glazings and which are very black have an L* value of around 5. The layer of paint partially covering the substrate according to the present invention typically has a lightness value of around 29 when it is deposited on a clear glass substrate and measured after drying and tempering. A “clear” glass is understood to mean a glass having a light transmission factor TL under D65 illuminant that is greater than or equal 90% when it is measured on a glass sheet having a thickness of 4 mm. The substrate according to the present invention is a tinted glass having a low light transmission TLA. The lightness L* of the paint measured through the tinted glass after drying and tempering is advantageously less than 5.

Thus, the paint according to the present invention makes it possible, due to the presence of certain mineral filler, preferentially in well-defined amounts, to increase the mechanical strength, while maintaining the desired requirements as regards coloration, in particular since it is deposited on a tinted glass substrate.

The optical density or absorbance of the paint, i.e. the ability to absorb the light that passes though it, corresponds to the given specification for the desired applications, since it is greater than 2 for a layer having a thickness of around 20 μm deposited on clear glass. This density is perfectly comparable with that of enamels. This absorbance value measured on untinted clear glass makes it possible to achieve the desired specification, which is at least 3 on tinted glass. The density is measured by transparency, since the amount of light transmitted by the enamel is measured relative to the transparency. The optical density OD is defined by the following formula:

$$OD = log \frac{1}{transparency}$$

Thus, a glass substrate coated with a layer of enamel which lets through 50% of the light has a transparency of 0.5 and the optical density measured is equal to 0.3. An optical density of 3 corresponds to a very opaque substrate since it only lets 0.1% of light through.

The roughness Ra of the paint layer, defined in standard ISO 4288 as being the arithmetic mean roughness of the profile and measured using a profilometer or roughness meter (for example of Dektak XT type marketed by Brucker) also meets the requirements desired for this application since it is preferably less than 1 μm.

The paint also has sufficient adhesion, in a cross-cut test according to standard ISO 2409: 2007 since it is preferably less than or equal to 2, or even less than or equal to 1.

The present invention also relates to a process for manufacturing a temperable tinted glass substrate, of which at least one portion of one of the faces thereof is coated with a mineral paint, characterized in that it comprises at least the following steps:

a. applying, to a tinted glass substrate, at least one layer of a paint composition based on a solution of alkali metal silicate in water comprising the mixing of a platy mineral filler with at least one other filler chosen from alumina, boron or germanium, and at least one black mineral pigment, the weight ratio between the alkali metal silicate and all of the mineral fillers including the pigment preferably being between 0.05 and 2,

b. drying said layer at a temperature below or equal to 250° C.

The aqueous mineral paint composition is preferably applied to at least one edge of the tinted glass substrate, the light transmission of which under D65 illuminant is less than 30%, preferably less than 20% for a substrate having a thickness of 4 mm, the transmission being measured on a portion of the substrate not coated with said paint.

The step of applying the paint composition is carried out by spray coating, roll coating, laminar flow coating, by digital printing or by screen printing. Preferably, the application step is varried out by screenprinting, and may therefore be integrated into existing assembly lines currently on motor vehicle glazing production lines in which the enamels are also deposited by screenprinting techniques.

Preferentially, the step of drying the paint is carried out at a temperature below 210° C. This relatively low temperature allows the water present in the mineral paint composition to be eliminated. The process according to the invention is consequently highly advantageous compared to existing current processes in which enamel-type paints are deposited on the glass substrates and must be heated at significantly higher temperatures (of around 700° C.) so that the glass frit melts and so that the paint can adhere sufficiently to the glass substrate.

Once dried, the mineral paint adheres sufficiently to the tinted glass substrate so that it can undergo a high-temperature heat treatment (tempering), according to the standard processes normally used in the motor vehicle field.

The present invention also relates to motor vehicle roofs capable of being obtained after thermal tempering of a glass substrate as described above or manufactured according to the process described above.

The examples below illustrate the invention without limiting the scope thereof.

### EXAMPLE 1

The mineral paint is prepared by mixing, in a mixer with vigorous mechanical stirring, the following amounts:
63.1 g of water with 0.2 g of thickener (Betolin V30) and with 0.6 g of wetting agent (Tego® 740 Evonik)
Addition of 0.1 g of antifoam (Foamex 825) and of 20 g of Fe—Mn black pigment (Black 444 Shepherd)
Addition of 14 g of talc (Jetfine 1A) with 62 g of alumina (CTC20 Almatis)
Addition of 40 g of the potassium silicate solution (K42T Woellner) which is a solution composed of 40% by weight of silicate and of 60% by weight of water.

The mixing is carried out so as to obtain a pasty paint, that is as homogeneous as possible, with no lumps.

The weight ratio between the potassium silicate and all of the mineral fillers including alumina, talc and black pigment is 0.17.

The paint is then passed through a three-roll mill in order to refine the microstructure of the elements of the formulation (in particular the mineral powders) and to complete the homogenization thereof.

The paint is deposited on a 4 mm thick tinted glass substrate having a TLA of less than 18% with the aid of a film coater then is dried in a drying oven at 200° C. for 20 minutes then cured in a chamber at 760° C. for 180 seconds, before being cooled to 20° C. The thickness of the paint after drying is 30 μm and the lightness value L* measured after drying and tempering is less than 5.

Flexural rupture measurements were carried out on the sample thus obtained, with the aid of a ring-on-tripod apparatus in order to evaluate the weakening thereof.

The ring-on-tripod flexural test is carried out using an Instron 4400R machine, which can drop a metal part (ring) on a test specimen. The machine is equipped with a 10 kN force sensor. The ring is made of tempered steel with a diameter of 10 mm and is fixed with a torus having a radius of 1 mm at the end of the Instron machine. The Instron machine also comprises a base on which three balls with a radius of 5 mm are adhesively bonded, these balls being positioned at 120° over a circle with a radius of 20 mm, the center of which is coincident with the center of the ring.

The test specimen is 70 mm×70 mm glass with a thickness of 3.85 mm, optionally coated on one of its faces with the paint to be analyzed. The test specimen rests on the three balls of the base and is aligned with the centre of the ring, to within 1 mm. An adhesive film is applied to the uncoated face of the test specimen in order to retain the pieces of the test specimen when it breaks and to verify that the rupture indeed lies at the center of the sample. Once the test specimen is in place, the ring comes into contact with the surface of the test specimen and an increasing force is then applied to the ring until the test specimen breaks. Only the test specimens for which the origin of breakage is under the ring are counted. The breaking stress as a function of the force at break and of the thickness of the test specimen is given by the following formula:

$${σ}_{( MPa )} = K \cdot Force ( DaN ) with K = 9.4091 \times \frac{1}{thickness {( mm )}^{2}} + 0.018$$

The results show that the probability of the test specimen tested breaking reaches 50% for a stress of 150 MPa. By way of comparison, the probability of an equivalent glass substrate coated with a 15 μm thick enamel layer breaking is 100 MPa.

### EXAMPLE 2

A paint is prepared as in example 1, replacing the potassium silicate solution with a sodium silicate solution comprising 45% by weight of silicate and 55% by weight of water (50/50 weight ratio of a Woellner Betol 39T and Betol mixture).

The weight ratio between the potassium silicate and all of the mineral fillers including alumina, talc and black pigment is 0.19. The thickness of the layer deposited and the drying and curing heat treatment is identical to that described in example 1.

The probability of the test specimen tested breaking reaches 50% for a stress of 160 MPa.

### EXAMPLE 3

The same paint as that described in example 1 is deposited so as to form, after drying and curing, a 5 μm thick layer.

The probability of the test specimen tested breaking reaches 50% for a stress of 180 MPa. By way of comparison, the probability of an equivalent glass substrate coated with a 5 μm thick enamel layer breaking is 90 MPa, and is 170 MPa for a bare substrate without any layer.

### EXAMPLE 4

The same paint as that described in example 2 is deposited so as to form, after drying and curing, a 5 μm thick layer.

The probability of the test specimen tested breaking reaches 50% for a stress of 195 MPa.

### EXAMPLE 5

### Not in Accordance with the Invention

A paint is prepared as an example 1, replacing the alumina with copper II oxide (Sigma-Aldrich) in equivalent amounts.

The thickness of the layer deposited and the drying and curing heat treatment is identical to that described in example 1.

The probability of the test specimen tested breaking reaches 50% for a stress of 90 MPa.

### EXAMPLE 6

### Not in Accordance with the Invention

A paint as prepared as in examples 1 and 5, modifying the amounts of talc and copper oxide: 6 g of talc (Jetfine 1A) are mixed with 68 g copper II oxide. The weight ratio between the silica and all of the mineral fillers remains unchanged.

The thickness of the layer deposited and the drying and curing heat treatment is identical to that described in example 1.

The probability of the test specimen tested breaking reaches 50% for a stress of 75 MPa.

1. A temperable tinted glass substrate, at least one of the faces of which is partially coated with a layer of mineral paint obtained from an aqueous paint composition based on an alkali metal silicate solution comprising the mixing of a platy mineral filler with at least one other filler chosen from alumina, boron or germanium, and at least one black mineral pigment.

2. The substrate as claimed in claim 1, wherein a weight ratio between the alkali metal silicate and all of the mineral fillers including the pigment is between 0.05 and 2.

3. The substrate as claimed in claim 2, wherein the weight ratio between the alkali metal silicate and the mineral fillers including the pigment is between 0.1 and 1.

4. The substrate as claimed in claim 1, wherein the platy mineral filler is talc, mica, or clays based on silicate or on aluminosilicate.

5. The substrate as claimed in claim 1, wherein the aqueous mineral paint composition comprises between 10% and 55% by weight of sodium silicate, potassium silicate and/or lithium silicate.

6. The substrate as claimed in claim 1, wherein the mineral paint composition further comprises a dispersant, an anti-foaming agent, a thickener, a stabilizer and/or a curing agent, in amounts of between 0.01% and 5% by weight of the aqueous mineral paint composition.

7. The substrate as claimed in claim 1, which is obtained by drying the aqueous paint composition at a temperature below 250° C.

8. The substrate as claimed in claim 1, wherein the mineral paint layer, measured after drying, has a thickness of at least 1 μm.

9. The substrate as claimed in claim 1, wherein a light transmission TLA of the substrate is less than 30%, the TLA being measured on a portion of the substrate having a thickness of 4 mm that is not coated with mineral paint.

10. The substrate as claimed in claim 1, wherein the lightness component L* measured in reflection on a portion of the glazing coated with the mineral paint layer is less than 5.

11. A process for manufacturing a temperable tinted glass substrate, of which at least one portion of one of the faces thereof is coated with a mineral paint, the process comprising:
a. applying, to a tinted glass substrate, at least one layer of a paint composition based on a solution of alkali metal silicate in water comprising the mixing of a platy mineral filler with at least one other filler chosen from alumina, boron or germanium, and at least one black mineral pigment, the weight ratio between the alkali metal silicate and all of the mineral fillers including the pigment preferably being between 0.05 and 2,
b. drying said layer at a temperature below or equal 250° C.

12. The process as claimed in claim 11, wherein the paint composition is applied to at least one edge of the tinted glass substrate, a light transmission of which under D65 illuminant is less than 30% for a substrate having a thickness of 4 mm, the transmission being measured on a portion of the substrate nt coated with said paint.

13. The process as claimed in claim 11, wherein the step of applying the paint composition is carried out by spray coating, roll coating, laminar flow coating, by digital printing or by screen printing.

14. The process as claimed claim 11, wherein the drying step is carried out at a temperature below 210° C.

15. A motor vehicle roof obtained after thermal tempering of a substrate as claimed in claim 1.

16. The substrate as claimed in claim 3, wherein the weight ratio between the alkali metal silicate and the mineral fillers including the pigment is between 0.1 and 0.3.

17. The substrate as claimed in claim 4, wherein the clays include kaolinite, illite, montmorillonite or sepiolite.

18. The substrate as claimed in claim 5, wherein the aqueous mineral paint composition comprises between 15% and 25% by weight of sodium silicate, potassium silicate and/or lithium silicate.

19. The substrate as claimed in claim 8, wherein the mineral paint layer, measured after drying, has a thickness of at least 5 μm.

20. The process as claimed in claim 12, wherein the light transmission is less than 20%.
